(19) United States
(12) Patent Application Publication
(10) Pub. No.: US 2014/0271264 A1
(43) Pub. Date: Sep. 18, 2014

(54) Piston pump drive train anti-backlash

(71) Applicants: Anthony Florindi, Norfolk, MA (US); Clifford James Reil, Buzzards Bay, MA (US)

(72) Inventors: Anthony Florindi, Norfolk, MA (US); Clifford James Reil, Buzzards Bay, MA (US)

(21) Appl. No.: 13/838,146

(22) Filed: Mar. 15, 2013

(51) Int. Cl. F04B 17/00; F16H 25/20

(52) U.S. Cl. CPC F04B 17/00; F16H 25/2003
USPC 417/321; 74/409

(57) ABSTRACT

An anti-backlash nut assembly for a positive displacement pump assembly includes a two part nut assembly and a backing plate. A spring is disposed between the backing plate and the nut assembly so that the two nut components are pushed together thus biasing the threads together and educing or eliminating backlash.

### BACKGROUND

Pumps used in biotech systems and applications, in vitro diagnostics and/or analytical instruments and systems such as liquid chromatography, including high performance and ultra high pressure liquid chromatography, capillary electrophoresis, and mass spectrometry systems require high accuracy and precision. In addition such systems often involve high pressures, potentially corrosive agents, and very small sample sizes. The pumps to be used in such systems thus require exacting designs to meet these objectives.

High precision fluid dispensing systems can utilize a positive displacement pump in which a stepper motor controls the position of a piston. Upon actuation, the stepper motor armature rotates in finite angular steps, thus rotating a lead screw or threaded shaft. This rotation is converted to linear motion through a threaded nut at the central axis of the motor armature. The nut, which can be splined to preclude rotation engages the threaded shaft. As the armature turns, the rotary motion is converted to linear motion of the nut, which is transferred to a piston enclosed in the pump volume. The piston moves in or out of the volume depending on the direction of rotation. The piston volume at full stroke determines the maximum operating volume of the pump. As the piston moves into the pump volume, a volume of fluid equal to the change in the piston volume is dispensed. One example of a high precision pump is the V-series pump commercially available from IDEX Health & Science of Middleboro, Mass.

Two issues that can affect pump function and longevity are backlash and friction. Backlash is the amount of lost motion due to play or clearance between mating components in a mechanical system. For the positive displacement pumps addressed herein, the mating components are the threads of the lead screw and the mating threads on the nut. When there is a significant clearance between the mating threads, during the initial motion of the lead screw, particularly as the direction of rotation is reversed, its threads would not be in contact with the threads of the nut, causing inaccuracy in the piston motion. However, a precise fluid dispensing system such as the positive displacement pump of this disclosure relies on having little or no backlash in the drive train in order to be considered an accurate dispensing tool.

Any solution for the reduction of backlash, however, must also consider increased friction that could be a side result of the backlash solution. Increased friction can decrease axial force output translated from motor torque and can also shorten pump longevity and increase maintenance costs and down time. The conventional anti-backlash methods, either biasing the nuts apart or radial pressure, induce more friction within the threads. Methods that push the threads apart require the spring force to be greater than the pump hydrostatic force in order to keep equilibrium between the two thread halves. The radial designs load both the leading and trailing thread flanks. This creates twice the friction used in either a push or pull method.

In many applications, it is desirable to have a pump that will have an expected lie and perform accurately through one million or more cycles, and even more preferably to perform to five million or more cycles, which is the expected life of the instrumentation. There is still a need in the art, therefore, for an anti-backlash method to be used in pumps that can minimize increased friction or wearing of the threads, in order to address backlash while preserving pump longevity.

### SUMMARY

The present disclosure addresses the problems of the prior art by providing an anti-backlash nut assembly for a pump that pushes the threads together rather than pulling them apart. This method requires a smaller spring force than is required for systems that push the nut halves apart, and allows the same side of the thread flank on both nut halves to be loaded. This method thus reduces production cost and maintenance and increases pump longevity and performance when compared to prior art anti-backlash devices.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is an example of a positive displacement pump.

FIG. 2 is a cross-sectional view of an embodiment as shown in FIG. 1.

FIG. 3 is an embodiment of an anti-backlash nut assembly for use in a positive displacement pump.

FIG. 4 is an end view of the embodiment shown in FIG. 3.

FIG. 5 is an exploded view of the embodiment shown in FIG. 3.

FIG. 6 is a cross-sectional view of an embodiment of an anti-backlash nut assembly in a pump.

FIG. 7 is a second embodiment of an anti-backlash nut assembly.

FIG. 8 is an exploded view of an anti-backlash nut assembly as shown in FIG. 7.

FIG. 9 is a cross-sectional view of an anti-backlash nut assembly as shown in FIG. 7.

### DETAILED DESCRIPTION

The present disclosure is directed to systems and methods of reducing backlash in a positive displacement pump system including an anti-backlash nut assembly and a positive displacement pump including the nut assembly. The pump works by reciprocal action of a piston in a chamber in which the piston is withdrawn, creating vacuum and pulling liquid into the chamber and on the reverse stroke expelling the fluid. In the pump, rotary motion is converted to linear motion by a mechanism that includes motor shaft attached to an externally threaded lead screw that turns in a nut assembly. Backlash is caused by clearance between the mating threads. As described herein, the nut assembly can include a primary nut, which engages the piston and a secondary nut, which is disposed on the motor side of the assembly. The two components can be interchangeably referred to as a primary nut and a secondary nut or as nut halves. The primary nut is used to describe the nut that contacts the piston and the secondary nut is between the primary nut and the motor.

The anti-backlash mechanisms of the present disclosure reduce or eliminate backlash by removing clearance between the internal threads of the primary and secondary nuts and the external threads of the lead screw. As used herein, reducing backlash refers to reducing measurable backlash by a detectable amount, usually indicated by percent of total pump volume. Eliminating backlash refers to reducing backlash to near the limit of the appropriate volume measurement capability. With the disclosed devices and methods, the reduction or elimination of backlash is accomplished in a novel way by biasing the nuts together. In conventional anti-backlash pump assemblies, the primary and secondary nuts are pushed apart or subjected to radial pressure to reduce the clearance between the internal and external threads.

The disclosed nut assemblies provide advantages specifically for a pump system as opposed to a system with an equal load in both directions. In a positive displacement pump, aspiration is the process of drawing fluid into the piston chamber. This process draws a vacuum thus creating an opposing load to the spring tension. During the dispensing process hydrostatic force is created in the opposite direction tending to push the primary and secondary nuts together. The force on the spring is thus substantially lower during fluid aspiration compared to dispensing. In biasing the nuts apart, therefore, the spring force is required to balance the much higher dispensing hydrostatic force. For example, a typical aspiration force in a liquid chromatography application the dispensing hydrostatic force can be up to 150 times higher than the vacuum in the aspiration cycle.

The disclosed devices and methods, therefore do not require a large spring force to balance the hydrostatic load imposed on the threads during the dispensing step as is necessary with systems that bias the nuts apart from. In the disclosed devices, the necessary restoring spring force is derived by only having to keep the two threads in equilibrium during an aspiration cycle, which is at much lower pressure. Another advantage over the prior methods is uniform loading of threads with a single spring.

Certain preferred embodiments of the disclosure are shown in the attached figures. FIG. 1 is a representation of an assembled pump 10. The pump housings contain the step motor assembly 12, the fluid chamber 14 and dispensing port 16. A cross-section of the pump is shown in FIG. 2. The lead screw 20 is attached to rotor 21, and threaded through the anti-backlash nut assembly, which includes a primary nut 22 and secondary nut 24 which engages the piston 26. A backing plate 28 is joined to the nut assembly by shoulder screws 30. The shoulder screws pass through the secondary nut 24 and also pin the primary nut 22 so the nuts do not rotate with the lead screw 20. A single spring 32 biases the secondary nut 24 and primary nut 22 together, holding the threads in tension and thus reducing or eliminating backlash.

A side view of an isolated anti-backlash nut assembly is shown in FIG. 3. This view clearly shows the relationship of the spring 32 disposed between the backing plate 28 and the secondary nut 24, biasing the secondary nut toward the primary nut 22. A perspective view of the end of the nut assembly is shown in FIG. 4, showing the heads of the shoulder screws 30 securing the backing plate 28.

An exploded view of the nut assembly is shown in FIG. 5. In this embodiment, three screws 30 attach the backplate 28 to the two nut halves, 22, 24. A single wave spring 32 is disposed between the backplate and the nuts.

As described above, the positive displacement pump works by converting the rotating of the lead screw through a non-rotating nut which moves along the screw pushing the piston in or out of the fluid chamber. In FIG. 6, the pump is at or near the maximum aspiration point of the cycle, as the nut 22 has moved along the screw 20 toward the motor drawing fluid into the dispensing chamber 14. In the dispensing portion of the cycle the nut 22 moves along the screw 20 toward the fluid chamber 14 pushing the piston into the chamber and displacing the fluid which is pumped out the outlet port. The pump shown in FIG. 2 illustrates the pump at the maximum dispensing position.

A second embodiment of the anti-backlash nut assembly is shown in FIG. 7-9. In this embodiment the lead screw 120 is threaded through the secondary nut 124 and primary nut 122 which engages the piston 126. This embodiment offers a further advantage in that the spring preload can be easily adjusted up or down. In this embodiment the primary nut 122 includes an externally threaded portion 125 that allows the secondary nut 124 to be threaded onto the primary nut 122 instead of attachment with shoulder screws, as best seen in FIG. 8. To accomplish the object of eliminating or reducing backlash with a single spring by biasing the nuts together, the secondary nut was split into two parts and the spring and washer placed inside the nut in order to bias it toward the primary nut. When assembling the device, a first part 140 of the secondary nut is placed on the primary nut projection and over the pins 144. The spring 132 is then placed over the threaded portion 125 of the primary nut 122. Next a washer 142 is threaded onto the primary nut projection 125 and tightened against the spring 132. The amount of preload on the spring can be adjusted by the tightness of this washer. Finally, the second part of the secondary nut 124 is threaded on the primary nut 122 and onto external threads on the first part 140 of the secondary nut. The pins 144 pass through the first part 140 of the secondary nut and into slots on the second part 124 to prevent rotation of the nuts during use. The spring thus biases the secondary nut 124 toward the primary nut 122 to eliminate backlash.

This embodiment can be better understood from the cross-section view with the lead screw 120 in place in FIG. 9.

While not limited by size unless otherwise indicated, in certain embodiments the precision dispense positive displacement pump assemblies of the disclosure have a pump volume of from about 25 μl to about 5000 μl as used in automated chemical reactions or liquid chromatography applications, or in certain embodiments a volume of 25 μl, 50 μl, 100 μl, 250 μl, 500 μl, 1000 μl, 2500 μl or 5000 μl. Such pumps can have a pump stroke of from about 0.25 to 1.0 inch, or in certain embodiment 0.5 inches. The lead screw for such instruments can typically have a resolution of 20 turns per inch or 40 turns per inch.

The anti-backlash nut assemblies described herein can be used with various pumps including low pressure pumps with pressures no greater than 100 psi and high pressure pumps with pressures up to 1500 psi or greater. The materials can be any appropriate materials known in the art, depending on the application. In certain embodiments, the backplate can be manufactured of stainless steel and the ferrules or nuts manufactured of natural PEEK (polyether ether ketone), for example.

All of the devices and methods disclosed and claimed herein can be made and executed without undue experimentation in light of the present disclosure. While the devices and methods of this invention have been described in terms of preferred embodiments, it will be apparent to those of skill in the art that variations may be applied to the devices and/or methods and in the steps or in the sequence of steps of the methods described herein without departing from the concept, spirit and scope of the invention. All such similar substitutes and modifications apparent to those skilled in the art are deemed to be within the spirit, scope and concept of the invention as defined by the appended claims.

1. A pump assembly comprising:
a step motor:
a rotary shaft driven by the step motor;
an externally threaded lead screw attached to the rotary shaft;
a fluid chamber comprising an inlet port and an outlet port;
a primary nut comprising an internally threaded central aperture;
a secondary nut comprising an internally threaded central aperture aligned with the central aperture of the primary nut;
a backing plate attached to the secondary nut opposite the primary nut;
a spring disposed between the backing plate and the secondary nut, effective to bias the secondary nut toward the primary nut; and
a piston disposed in the fluid chamber and attached to the primary nut;
wherein the lead screw is threaded through the secondary and primary nuts effective to transfer rotary motion of the lead screw to linear motion of a piston within the fluid chamber.

2. The pump assembly of claim 1, wherein the spring force is selected to balance the vacuum force against the secondary nut when the pump is in the aspiration cycle.

3. The pump assembly of claim 1, wherein the spring is a single wave spring.

4. The pump assembly of claim 1, wherein the backing plate is attached to the secondary nut and primary nut by one or more screws.

5. The pump assembly of claim 1, wherein the pump volume is from about 25 μl to about 5000 μl.

6. An anti-backlash nut assembly for a positive displacement pump assembly comprising:
a primary nut comprising a threaded central aperture;
a secondary nut comprising a threaded central aperture aligned with the threaded central aperture of the primary nut;
a backing plate attached to the secondary nut; and
a spring disposed between the backing plate and the secondary nut such that, when assembled, the secondary nut is biased toward the primary nut.

7. The anti-backlash nut assembly of claim 6 further comprising a piston attached to the primary nut.

8. An anti-backlash nut assembly for a positive displacement pump assembly comprising:
a primary nut comprising a threaded central aperture and an externally threaded extension of the central aperture and one or more pins extending in the same direction as the projection;
a two piece secondary nut, an inner piece of the secondary nut comprising external threads and an outer piece of the secondary nut comprising a threaded central aperture and threaded onto the externally threaded projection of the primary nut and threaded onto the external threads of the inner piece of the secondary nut, and each of the secondary nut pieces comprising one or more holes or slots to receive the pins on the primary nut;
a threaded washer disposed between the two pieces of the secondary nut and threaded onto the externally threaded projection of the primary nut; and
a spring disposed between the washer and the inner piece of the secondary nut effective to bias the secondary nut toward the primary nut.

9. A method of reducing backlash in a positive displacement pump assembly comprising:
providing a nut assembly for a positive displacement pump wherein a primary nut and a secondary nut are separately threaded onto a lead screw of the pump and a piston is attached to the primary nut and extends into a fluid chamber;
providing a spring that biases the secondary nut toward the primary nut; and
selecting the spring force to balance the vacuum force created in a fluid chamber during the aspiration step of a positive displacement pump cycle.
